(19) United States
(12) Patent Application Publication
(10) Pub. No.: US 2006/0078361 A1
(43) Pub. Date: Apr. 13, 2006

(54) Developing unit and image forming apparatus adopting the same

(75) Inventor: Jong-hyun Park, Yongin-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/240,563

(22) Filed: Oct. 3, 2005

(30) Foreign Application Priority Data
Oct. 2, 2004 (KR) 10-2004-0078549

(51) Int. Cl. G03G 21/00

(52) U.S. Cl. 399/359

(57) ABSTRACT

A collecting unit to be used in an image forming apparatus having a waste toner storing chamber and a development chamber, the collecting unit including a collection passage connecting the waste toner storing chamber and the development chamber; and a movable first transfer unit provided in the collection passage to move waste toner from the waste toner storing chamber to the development chamber.

### CROSS-REFERENCE TO RELATED APPLICATIONS

This application claims the benefit of Korean Patent Application No. 10-2004-0078549, filed on Oct. 2, 2004, in the Korean Intellectual Property Office, the disclosure of which is incorporated herein by reference.

### BACKGROUND OF THE INVENTION

1. Field of the Invention

The present invention relates to an image forming apparatus, and, more particularly, to an image forming apparatus having a transfer unit to forcibly transfer toner so as to prevent a toner collection passage from being blocked by collected toner that is hardened when the wasted toner is collected for reuse.

2. Description of the Related Art

In general, image forming apparatuses receive a digital image signal and form an electrostatic latent image on a photosensitive medium coated with a conductive material, by using an exposure unit like a laser scanning unit. The electrostatic latent image is developed into a toner image using toner. The toner image is transferred to a recording medium. By applying heat and pressure to the toner image on the recording medium, the toner image is fused thereon so that a desired image is obtained.

The image forming apparatus can be generally classified into a dry type or a wet type according to the state of toner and carrier being used. The dry type can also be classified into an image forming apparatus having a 1-phase developing unit or an image forming apparatus having a 2-phase developing unit.

In the 1-phase developing unit, only toner is provided to form an image. In the 2-phase developing unit, toner and a carrier to which toner particles are attached are provided to form an image.

In the 1-phase developing unit, the toner is provided to the photosensitive medium to develop the toner image, and then the toner remaining on a surface of the photosensitive medium is removed by a cleaning blade and collected by a collecting unit for reuse. Also, in the 2-phase developing unit, the carrier is collected without being provided to the photosensitive medium, while the toner particles only are provided to the photosensitive medium to develop the toner image. Thereafter, the toner particles remaining on the surface of the photosensitive medium are removed by a cleaning blade and collected by the collecting unit for reuse. The above descriptions relate to a case of forming a black and white image. When a color image is formed, since a color toner image on the surface of the photosensitive medium is a mixture of toner of various colors, the toner remaining on the photosensitive medium is difficult to be reused.

The following descriptions relate to only a case in which toner is collected for reuse in the 1-phase developing unit or 2-phase developing unit.

As described above, in the process of collecting the toner removed from the photosensitive medium by the cleaning blade, when toner formed of light powder particles are accumulated and hardened on a toner collection passage, the toner collection passage may become blocked. When the toner collection passage is blocked, the toner collected for reuse is not provided into a development chamber and discharged out of the developing unit, and therefore a main body may be contaminated. Also, since the rotational torque of a toner transfer apparatus is increased, the toner transfer apparatus can be damaged.

Furthermore, since the toner collection passage is blocked, the developing unit having an otherwise sufficient life span needs to be replaced earlier, which is disadvantageous to an aspect of cost saving.

### SUMMARY OF THE INVENTION

To solve the above and/or other problems, the present invention provides a developing unit having a transfer unit which can forcibly transfer toner on a toner collection passage to prevent the toner collection passage from being blocked by the toner during the collection of the toner for reuse, and an image forming apparatus adopting the same.

Additional aspects and/or advantages of the invention will be set forth in part in the description which follows and, in part, will be apparent from the description, or may be learned by practice of the invention.

According to an aspect of the present invention, a collecting unit to be used in a developing unit of an image forming apparatus having a waste toner storing chamber and a development chamber is provided, the collecting unit including a first transfer unit provided in the waste toner storing chamber; a second transfer unit provided in the development chamber; a collection passage connecting the waste toner storing chamber and the development chamber; and a third transfer unit provided in the collection passage, rotatable by being coupled to the second transfer unit, to transfer waste toner to the development chamber.

According to another aspect of the present invention, a collecting unit to be used in an image forming apparatus having a waster toner storing chamber and a development chamber is provided, the collecting unit including a collection passage connecting the waste toner storing chamber and the development chamber; and a movable first transfer unit provided in the collection passage to move waste toner from the waste toner storing chamber to the development chamber.

The collecting unit may further include a second transfer unit provided in the development chamber, wherein the first transfer unit is coupled to the second transfer unit.

The second transfer unit may include a rotation shaft coupled to the first transfer unit, and the rotation shaft may rotate the first transfer unit.

A plurality of protrusions may be provided on the rotation shaft, the protrusions interacting with the first transfer unit to rotate the first transfer unit.

The first transfer unit may be divided into a plurality of sections to move the waste toner in separated portions.

According to another aspect of the present invention, a collecting unit to be used in an image forming apparatus having a waste toner storing chamber and a development chamber is provided, the collecting unit including a collection passage connecting the waste toner storing chamber and the development chamber, and a movable unit provided in the collection passage to agitate waste toner as the waste toner moves form the waste toner storing chamber to the development chamber.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a cross-sectional view illustrating the configuration of an image forming apparatus adopting a developing unit according to an embodiment of the present invention;

FIG. 2 is a perspective view illustrating the developing unit according to an embodiment of the present invention;

FIG. 3 is a partially exploded perspective view illustrating the developing unit of FIG. 2;

FIG. 4 is a magnified perspective view illustrating the transfer unit shown in FIG. 3; and

FIG. 5 is a cross-sectional view illustrating the operation of the transfer unit of FIG. 3.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

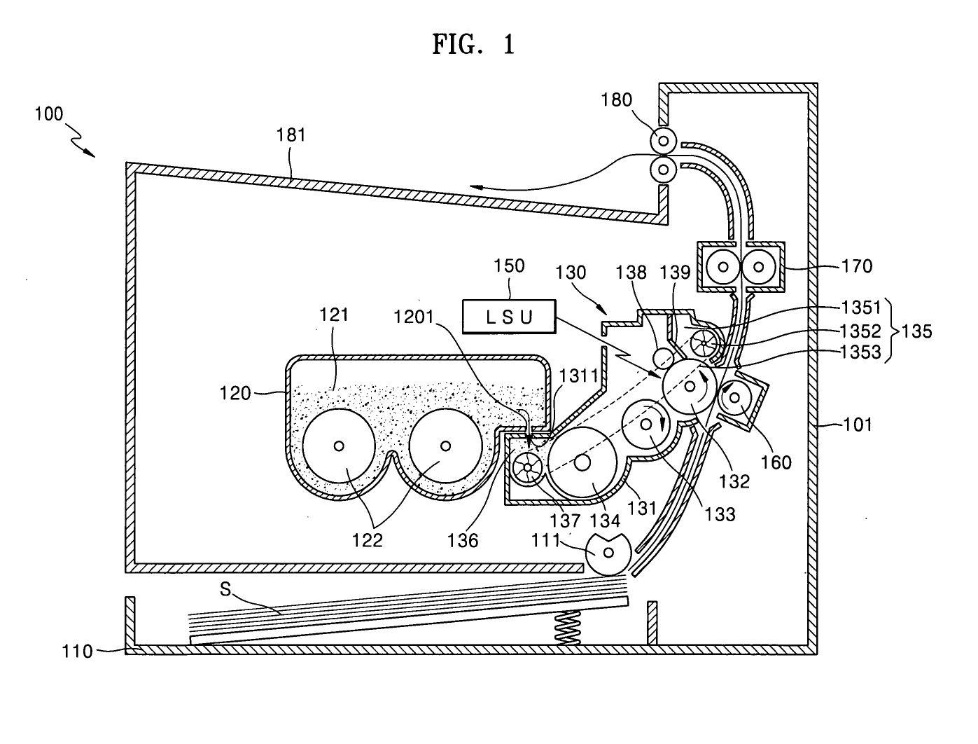

Referring to FIG. 1, an image forming apparatus 100 according to an embodiment of the present invention includes a cassette 110, a toner container 120, a developing unit 130, an exposure unit 150, a transfer roller 160, a fusing unit 170, and a paper eject unit 180.

The cassette 110, into which a recording medium S is loaded, is detachably installed in a main body 101. A pickup roller 111 to pick up the recording medium S sheet by sheet is rotatably installed in the main body 101 above the cassette 110.

The toner container 120 is detachably installed in the main body 101 and contains the toner 121, which is a developer. A plurality of agitating rollers 122 are provided in the toner container 120 to agitate the toner 121, so that the toner 121 is not hardened. When all of the toner 121 is used, the toner container 120 can be replaced with another toner container containing new toner.

The developing unit 130 is detachably installed in the main body 101 to develop an electrostatic latent image into a toner image. The developing unit 130 is housed by a housing 131, and includes a photosensitive drum 132, a magnet roller 133, a mixing roller 134, and a collecting unit 135.

An inlet 1311 is provided in the housing 131 at a portion facing the toner container 120. The inlet 1311 is provided to align with an outlet 1201 provided in the toner container 120 so that the toner 121 contained in the toner container 120 enters into a development chamber 136.

The photosensitive drum 132 is rotatably installed so that a portion of the photosensitive drum 132 is exposed outside of the housing 131. The photosensitive drum 132 is charged to a predetermined electric potential, and an electrostatic latent image is formed thereon using a difference in the electric potential by light emitted from the exposure unit 150.

The magnet roller 133 rotates close to the photosensitive drum 132 to attach the toner 121 to the photosensitive drum 132 using repulsion that is generated due to a voltage difference.

The mixing roller 134 is rotatably installed in the development chamber 136, and mixes new toner, provided from the toner container 120 through the inlet 1311, with waste toner, collected from the photosensitive drum 132, in the development chamber 136.

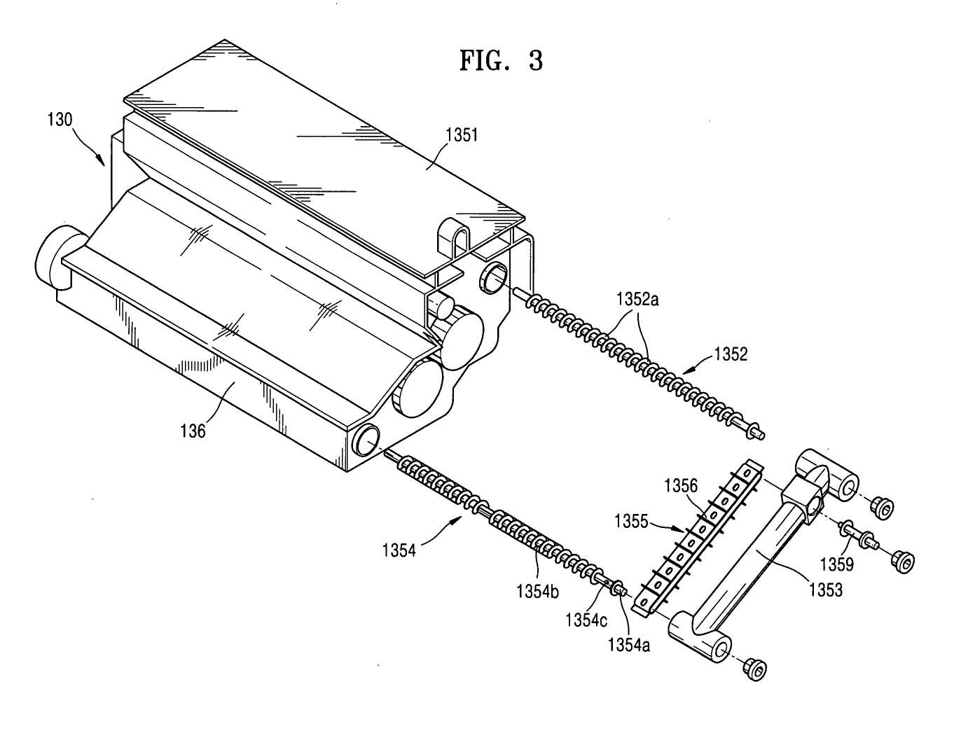

Referring to FIG. 3, the collecting unit 135 collects for reuse the waste toner which remains on the surface of the photosensitive drum 132 without being transferred to the recording medium S. The collecting unit 135 includes a waste toner storing chamber 1351, a collection screw 1352, a collection passage 1353, a transfer screw 1354, and a transfer unit 1355.

The waster toner storing chamber 1351 temporarily stores the waste toner removed from the photosensitive drum 132 by a cleaning blade 139 which is installed above the photosensitive drum 132.

The collection screw 1352 is rotatably installed in the waste toner storing chamber 1351, and transfers the waste toner stored in the waste toner storing chamber 1351 toward the collection passage 1353. As shown in FIG. 3, a wing 1352a is spirally arranged on the collection screw 1352. Thus, as the collection screw 1352 rotates, the waste toner is transferred to the collection passage 1353 along the lengthwise direction of the collection screw 1352.

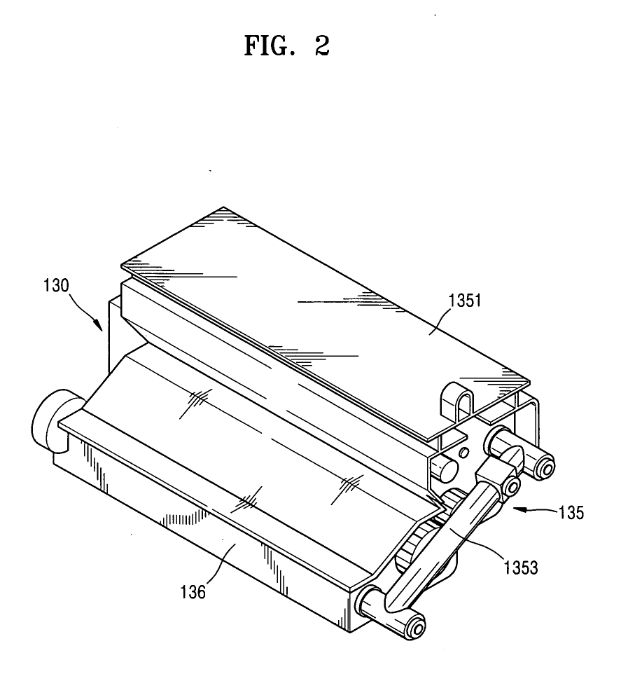

The collection passage 1353 connects the waste toner storing chamber 1351 and the development chamber 136 so as to transfer the waste toner stored in the waste toner storing chamber 1351. The collection passage 1353, as shown in FIGS. 1 and 2, is declined from the waste toner storing chamber 1351 down to the development chamber 136. The waste toner transferred by the collection screw 1352 slides down along the collection passage 1353 by the weight thereof, and is transferred toward the development chamber 136.

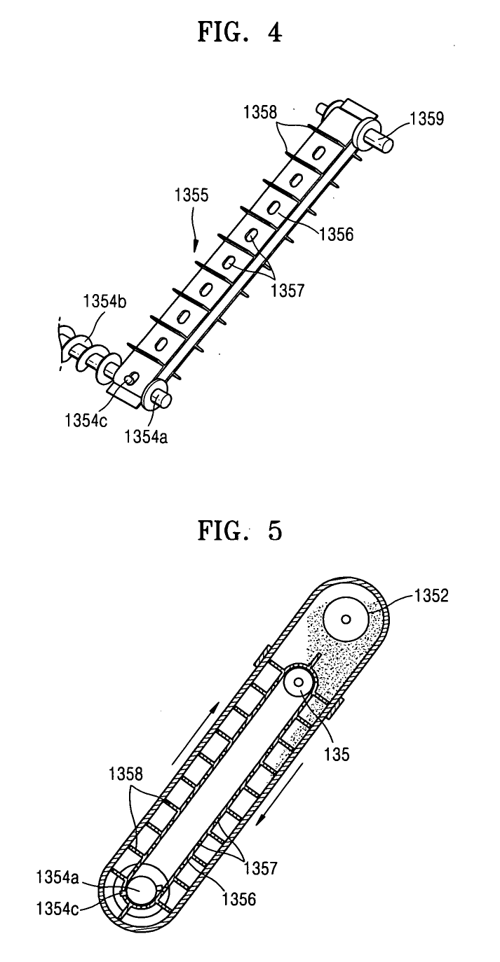

The transfer screw 1354 is rotatably installed in the development chamber 136, and transfers the waste toner transferred through the collection passage 1353 to the development chamber 136. As shown in FIG. 4, a wing 1354b is spirally formed on a rotation shaft 1354a of the transfer screw 1354.

Since the development chamber 136 is connected to the toner container 120, as shown in FIG. 1, new toner provided from the toner container 120 is mixed by the transfer screw 1354 with the waste toner transferred through the collection passage 1353.

The transfer unit 1355, as shown in FIGS. 3 and 4, is rotatably installed in the collection passage 1353 in a lengthwise direction of the collection passage 1353, to smoothly transfer the waste toner from the waste toner storing chamber 1351 to the development chamber 136. The transfer unit 1355 may be a belt 1356 having one end connected to the rotation shaft 1354a and the other end supported by an idle shaft 1359 rotatably installed in the collection passage 1353, having a closed curve shape as a whole.

A plurality of bosses 1354c may be provided at one side of the rotation shaft 1354a to protrude in a symmetrical form. A plurality of holes 1357 may be formed in the belt 1356 at a predetermined interval so that the bosses 1354c are inserted therein during rotation of the transfer screw 1354. Accordingly, as the rotation shaft 1354a rotates, the bosses 1354c are inserted in the holes 1357 so that the belt 1356 rotates with the rotation shaft 1354a.

In the present embodiment, although the bosses 1354c and the holes 1357 are provided at the rotation shaft 1354a and the belt 1356, respectively, to rotate the belt 1356, the present invention is not limited thereto, and various modified examples can be applied to rotate the belt 1356. For example, sawteeth may be formed on the inner circumferential surface of the belt 1356, and the outer circumferential surfaces of the rotation shaft 1354a and the idle shaft 1359, so that the belt 1356 is rotated as the belt 1356 is engaged with the rotation shaft 1354a and the idle shaft 1359.

A plurality of protrusions 1358 having a predetermined area may be provided on the outer circumferential surface of the belt 1356 to transfer the waste toner. The protrusions 1358 are preferably, though not necessarily, disposed between the neighboring holes 1357 so as not to overlap the holes 1357. The protrusions 1358 transfer the waste toner in a separated fashion, and agitate the waste toner to prevent hardening of the waste toner.

In the present embodiment, although bosses to be inserted in the holes 1357 are not separately provided at the idle shaft 1359, the present invention is not limited thereto, and bosses may be provided at the idle shaft 1359, either alternatively or in coexistence with the bosses 1354c provided at the rotation shaft 1345a.

The exposure unit 150 emits light onto the photosensitive drum 132, which is charged to a predetermined electric potential, to lower the electric potential of a portion receiving the light to be not more than the predetermined electric potential so as to form the electrostatic latent image. Generally, a laser scanning unit (LSU) is used as the exposure unit 150.

The transfer roller 160 is installed to contact the photosensitive drum 132 so as to press the recording medium S passing through a contact portion normally contacting the photosensitive drum 132. Thus, the toner image formed on the surface of the photosensitive drum 132 is transferred to the recording medium S.

The fusing unit 170 fuses the toner image on the recording medium S, and includes a heating roller to generate and apply heat to the toner image, and a press roller to press the toner image against the recording medium S.

The paper eject unit 180 ejects the recording medium S, on which the toner image is fused, out of the main body 101. As a plurality of rollers are rotated by being engaged with each other, the recording medium S is ejected outside. The recording medium S ejected by the paper eject unit 180 is loaded on a paper receiving plate 181.

Referring to FIGS. 1 through 5, when the developing unit 130 is installed in the main body 101, the respective rollers constituting the developing unit 130 may be rotated by being connected to a drive unit (not shown) provided in the main body 101.

When the rotation shaft 1354a rotates, as the bosses 1354c are inserted in the holes 1357 of the belt 1356, a rotational force is transferred to the belt 1356 so that the belt 1356 rotates in a direction indicated by arrows. While the belt 1356 rotates, the protrusions 1358 transfer the waste toner toward the development chamber 136 so that the waster toner can be prevented from being hardened in the collection passage 1353.

As described above, in the developing unit according to the present invention, since the belt, or other movable member, which is rotated by receiving a rotational force from the transfer screw, is installed in the collection passage to transfer waste toner, the waste toner is prevented from being hardened in the collection passage.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A collecting unit to be used in a developing unit of an image forming apparatus having a waste toner storing chamber and a development chamber, the collecting unit comprising:
a first transfer unit provided in the waste toner storing chamber;
a second transfer unit provided in the development chamber;
a collection passage connecting the waste toner storing chamber and the development chamber; and
a third transfer unit provided in the collection passage, rotatable by being coupled to the second transfer unit, to transfer waste toner to the development chamber.

2. The collecting unit of claim 1, further comprising:
an idle shaft rotatably provided in the collection passage;
wherein the third transfer unit comprises a belt having a closed curve shape which receives a rotational force from the second transfer unit, and is supported by the idle shaft.

3. The collecting unit of claim 2, wherein the second transfer unit comprises:
a rotation shaft; and
a plurality of bosses provided on the rotation shaft to symmetrically protrude therefrom;
wherein a plurality of holes formed in the belt at a predetermined interval to receive the bosses; and the belt is rotated as the bosses are inserted in the holes in response to the second transfer unit rotating.

4. The collecting unit of claim 3, further comprising a plurality of protrusions provided on an outer circumferential portion of the belt.

5. The collecting unit of claim 4, wherein the protrusions are disposed between the holes.

6. The collecting unit of claim 2, wherein the idle shaft is provided in the collection passage at a predetermined location so as to be rotatable in a direction perpendicular to a direction in which the waste toner is transferred.

7. An image forming apparatus comprising:
a waste toner storing chamber;
a development chamber and
a collecting unit comprising:
a first transfer unit provided in the waste toner storing chamber,
a second transfer unit provided in the development chamber,
a collection passage connecting the waste toner storing chamber and the development chamber to transfer waste toner,
and a third transfer unit provided in the collection passage,
wherein the third transfer unit is coupled to the second transfer unit to transfer the waste toner to the development chamber.

8. The image forming apparatus of claim 7, further comprising:
an idle shaft rotatably provided in the collection passage;
wherein the third transfer unit comprises a belt having a closed curve shape which receives a rotational force from the second transfer unit, and is supported by the idle shaft.

9. The image forming apparatus of claim 8, wherein the second transfer unit comprises:
a rotation shaft; and
a plurality of bosses provided on the rotation shaft to symmetrically protrude therefrom;
a plurality of holes formed in the belt at a predetermined interval to receive the bosses; and the belt is rotated as the bosses are inserted in the holes in response to the second transfer unit rotating.

10. The image forming apparatus of claim 9, further comprising a plurality of protrusions provided on an outer circumferential portion of the belt.

11. The image forming apparatus of claim 10, wherein the protrusions are disposed between the holes.

12. The image forming apparatus of claim 8, wherein the idle shaft is provided in the collection passage at a predetermined location so as to be rotatable in a direction perpendicular to a direction in which the waste toner is transferred.

13. A collecting unit to be used in an image forming apparatus having a waste toner storing chamber and a development chamber, the collecting unit comprising:
a collection passage connecting the waste toner storing chamber and the development chamber; and
a movable first transfer unit provided in the collection passage to move waste toner from the waste toner storing chamber to the development chamber.

14. The collecting unit of claim 13, further comprising a second transfer unit provided in the development chamber, wherein the first transfer unit is coupled to the second transfer unit.

15. The collecting unit of claim 14, wherein the second transfer unit comprises a rotation shaft coupled to the first transfer unit, and the rotation shaft rotates the first transfer unit.

16. The collecting unit of claim 15, wherein a plurality of protrusions are provided on the rotation shaft, the protrusions interacting with the first transfer unit to rotate the first transfer unit.

17. The collecting unit of claim 16, wherein the first transfer unit comprises a belt provided with holes to receive the protrusions.

18. The collecting unit of claim 16, wherein the protrusions are provided as bosses, and the first transfer unit comprises a belt provided with holes to receive the bosses.

19. The collecting unit of claim 16, wherein the protrusions are provided in a sawtooth shape, and the first transfer unit comprises a belt provided with sawtooth shaped protrusions on an inner circumference thereof to interact with the protrusions formed on the second transfer unit.

20. The collecting unit of claim 13, wherein the first transfer unit is divided into a plurality of sections to move the waste toner in separated portions.

21. The collecting unit of claim 20, wherein the plurality of sections are defined by a plurality of protrusions provided on the first transfer unit.

22. The collecting unit of claim 21, wherein the first transfer unit comprises a belt having a closed curve shape.

23. A collecting unit to be used in an image forming apparatus having a waste toner storing chamber and a development chamber, the collecting unit comprising:
a collection passage connecting the waste toner storing chamber and the development chamber; and
a movable unit provided in the collection passage to agitate waste toner as the waste toner moves from the waste toner storing chamber to the development chamber.
